(19) United States
(12) Patent Application Publication
(10) Pub. No.: US 2008/0112861 A1
(43) Pub. Date: May 15, 2008

(54) Thermal processing apparatus and methods

(75) Inventors: Brian K. Fisk, Portland, OR (US); John S. Dahl, Portland, OR (US)

Correspondence Address: KLARQUIST SPARKMAN, LLP, 121 SW SALMON STREET, SUITE 1600, PORTLAND, OR, 97204, US

(73) Assignee: DiGen Environmental Recovery Systems, Inc.

(21) Appl. No.: 11/977,400

(22) Filed: Oct. 23, 2007

Related U.S. Application Data
(60) Provisional application No. 60/854,013, filed on Oct. 23, 2006.

(51) Int. Cl. B01J 19/00

(52) U.S. Cl. 422/198

(57) ABSTRACT

Apparatus and methods are disclosed that perform thermal processing of any of various materials, including materials that ordinarily would be considered waste materials posing problems with disposal. Thermal processing can include energy recovery from the material, conversion of the material, phase change, or other process. An exemplary apparatus includes first and second liquid-processing chambers containing a liquid at a level in the first chamber lower than in the second. A flame chamber and downstream thermocatalytic chamber are immersed in the liquid in first chamber, and a dry loop is immersed in the liquid in the second chamber. The dry loop is coupled to a downstream processed/exhaust gas diffuser immersed in the first chamber. The temperature profile of a fluid stream drops as the stream passes through the apparatus. During passage, at least one thermal process is performed that contributes to the processed gas stream entering the diffuser. From the diffuser, the processed/exhaust gas is bubbled into the liquid, serving to scrub the gas, at least partially. Much of the thermal energy entering and produced in the apparatus is usefully captured.

### CROSS REFERENCE TO RELATED APPLICATION

This application claims priority to, and the benefit of, Provisional Application No. 60/854,013, filed on Oct. 23, 2006, which is incorporated herein in its entirety.

### FIELD

This disclosure pertains generally to apparatus and methods for thermally processing fluids such as waste gases and/or waste liquids, gaseous and/or liquid suspensions of solid materials, and the like to recover useful products and/or useful energy from such materials.

### BACKGROUND

Thermal processors utilize heat for executing a desired chemical or physical change to a substance or to things. A furnace is a type of thermal processor that produces heat, such as by combustion of a fuel or by application of electrical energy, for application to a thing, a space, or a substance. Other types of thermal processors receive heat energy from an external source and condition, augment, and/or direct the heat in a desired manner.

A well-known example of a thermal processor is a residential furnace that produces hot air or hot water for heating buildings. Another type of thermal processor applies heat for melting or shaping a material such as a metal for a desired purpose. Yet another type of thermal processor is used for heat-treating objects or materials (e.g., metals, glasses, and ceramics) for annealing purposes or to change a physical characteristic of the objects or materials. Yet another type of thermal processor is used for incinerating or otherwise converting waste material in a manner that reduces the volume of the waste, converts the Waste to a less noxious and/or more useful material, and/or forms from the waste a more easily handled material.

Another type of conventional thermal processor is generally termed an “evaporator,” which receives a target material (which can be a solid or liquid) and applies heat to the target material for converting at least a portion of the target material into a gas or vapor that can be used for another purpose or safely disposed. Evaporators have many uses, including separating a liquid from solids or from other substances present in the liquid, separating one type of liquid from a mixture containing at least one other type of liquid, or separating a liquid from a gas. For example, an evaporator used for separating a liquid from suspended solids in the liquid typically includes a heat source that heats the mixture to a temperature allowing separation of the liquid (e.g., by forming a vapor from the liquid and condensing the vapor) from the solids.

A substantial operational challenge associated with many conventional evaporators is dealing with the sludges and other substantially solid materials (usually waste materials) left behind from the evaporation. For example, a key problem with sludges and cakes is their tendency to accumulate in locations (such as on heated surfaces) in a manner that substantially reduces the efficiency or efficacy of the evaporator.

One conventional approach for minimizing accumulation of solid wastes in an evaporator involves conducting a primary evaporation in a manner in which the liquid to be evaporated is not in contact with a surface on which solid deposits can form. An example of such an evaporator is discussed in U.S. Pat. No. 5,381,742 to Linton et al., incorporated herein by reference.

Whereas a need for a suitable evaporator can arise in any of a wide variety of circumstances or locations, many types of evaporators simply are unsatisfactory for use in certain environments. One particularly difficult environment for an evaporator is in an oilfield, mine, test site, or other remote field location where access to utilities is difficult or impossible. Oil-drilling and other oil-well operations often yield any of various “by-product” substances (substances other than the desired oil and/or natural gas from the well). By-product substances can include brines and other noxious waters, oil-water mixtures, gas-water mixtures, gas-gas mixtures, mud slurries, and the like. Frequently, both gaseous and liquid by-products are produced by wells, often in substantial amounts. Most by-products are toxic or comprise toxic or at least noxious wastes that present substantial disposal problems. Proper disposal would be greatly facilitated if a practical way could be found to reduce the volume of such waste while converting at least some of the waste to material that could be returned safely to the environment and/or used on-site or nearby for a practical purpose.

Oil extraction from fields has been increased by various methods involving re-introduction of gas and/or liquid into the oil-bearing stratum in place of the petroleum removed from the stratum, and such methods are even being used to bring retired fields back into production. Some of these re-introduction schemes increase or restore oil yields simply by pressurizing the stratum, which urges more oil to flow up the well. Other re-introduction schemes aim to reduce the viscosity of residual petroleum in the stratum, which again urges greater flow of oil up the well. Whereas certain schemes could be performed simply by pumping raw by-product substances (e.g., brine) back into the stratum, such methods usually have unfavorable environmental consequences and may be prohibited by law. Hence, there is substantial interest in being able to convert, at a well site or similar location, at least some of these by-products into substances that are environmentally acceptable for re-introduction or other useful purpose. For example, CO₂ and/or N₂ injected into an oil-bearing stratum tend to reduce the viscosity of petroleum remaining in the stratum; purified (e.g., distilled) water injected into the stratum can facilitate breakup and dissolution of residual calcium silicates and sulfates. Both of these techniques can invigorate a retired well, including a well that may have sealed off completely, by tapping into the stratum. Whereas waste gases and liquids from a producing well may contain CO₂ and/or N₂, the wastes also typically include large amounts of noxious gases (such as sulfurous gases as well as hydrocarbon gases) and water-containing liquids and suspensions that may pollute ground water if re-introduced in a raw state into the stratum.

Hence, an evaporator or other thermal processor that could be placed at a well site and used for reclaiming well by-products in an efficient manner for useful purposes would be advantageous.

Further with respect to oil wells and other extraction sites of fossil fuels (including coal deposits), many of these sites contain substantial amounts of gaseous methane and other low-molecular-weight hydrocarbons as byproducts of extraction of the target material from the sites. The sites are usually poorly equipped to recover these gaseous byproducts, which almost always require treatment to make the byproducts commercially usable. Since the gaseous byproducts are usually combustible, if not recovered they are simply flared off or otherwise discharged into the atmosphere without any effort being made to recover useful energy from them. Hence, for these and other situations, there is a need for thermal processing apparatus that would allow for recovery and conversion of these gases and other reactive gases into a source of heat for on-site processing.

### SUMMARY

The foregoing and other needs are met by thermal processing apparatus and methods as disclosed herein.

An embodiment of a thermal-processing apparatus comprises a flame chamber, first and second liquid-processing chambers, at least one thermocatalytic chamber, a dry loop, and a processed/exhaust gas diffuser. Each of the first and second liquid-processing chambers contains a liquid. In many, if not most, instances, the liquid is water or a liquid comprising water. The liquid in the second liquid-processing chamber has a higher level than the liquid in the first liquid-processing chamber. The flame chamber is submerged below the liquid level in the first liquid-processing chamber and contains a flame substantially within the flame chamber. The flame can be produced by introducing and combusting any of various fuels (such as a waste gas available at the site) and a suitable oxidizer (such as air, oxygen, or other suitable oxidizer). The thermocatalytic chamber is coupled downstream of the flame chamber, is submerged in the liquid, and receives thermal energy from the upstream flame chamber. The thermal energy is in the form of a very hot gaseous stream (which can include suspended particulate solid(s) and/or liquid(s), depending upon fuel makeup) that is produced by the flame in the flame chamber. The thermocatalytic chamber executes at least one thermal process, utilizing at least a portion of the thermal energy received therein, on a processable material in thermal contact with the first thermocatalytic chamber. The dry loop is coupled to the thermocatalytic chamber, includes a portion that is elevated relative to the thermocatalytic chamber, and is submerged in the liquid in the second liquid-processing chamber. The dry loop conducts thermal energy and processed/exhaust matter produced upstream thereof (such as from the thermal process performed in the thermocatalytic chamber) while preventing incursion of liquid upstream of the dry loop into the thermocatalytic chamber and flame chamber. The processed/exhaust gas diffuser is coupled downstream of the dry loop and is submerged beneath the liquid level in the first liquid-processing chamber. The processed/exhaust gas diffuser receives thermal energy and processed/exhaust matter exiting the dry loop and discharges at least some of the thermal energy and matter as bubbles into the liquid in the first liquid-processing chamber.

The first and second liquid-processing chambers desirably are contained within a tank or analogous vessel that is conveniently transported and set up for use at a particular site.

As matter (gases, entrained droplets and/or particulates, etc.) propagates from the flame chamber and through the thermocatalytic chamber, dry loop, and processed/exhaust gas diffuser, the temperature of the matter generally decreases. That is, the temperature downstream is generally lower than the temperature upstream. The temperature does not necessarily progressively decrease, especially if an exothermic process is conducted in the thermocatalytic chamber. In any event, during operation the apparatus (particularly the thermocatalytic chamber) provides multiple thermal “sites” each having a respective temperature at which a respective thermal process can be conducted by the apparatus.

The thermocatalytic chamber desirably constitutes a primary thermocatalytic chamber submerged beneath the liquid level in the first liquid-processing chamber and located upstream of the dry loop, and a secondary thermocatalytic chamber coupled between the primary thermocatalytic chamber and the dry loop. The secondary thermocatalytic chamber receives thermal energy from upstream (e.g., produced in the flame and primary thermocatalytic chamber) and executes at least one thermal process, utilizing at least a portion of the received thermal energy, on an introduced processable material in thermal contact with the secondary thermocatalytic chamber. Being located downstream of the primary thermocatalytic chamber, the secondary thermocatalytic chamber is potentially at a lower temperature than the primary thermocatalytic chamber and can be used for performing one or more thermal processes requiring lower temperatures than process(es) performed in the primary thermocatalytic chamber.

In an embodiment of a method for performing a thermal process on a processable material, a fluid stream is provided and directed into a thermocatalytic chamber in which the fluid stream gains thermal energy from a flame chamber. The resulting hot fluid stream comprises one or more gases (exhaust gases, processed gases, processable gases), suspended solid(s), and/or suspended liquid(s). The increased-energy fluid stream is passed through a thermocatalytic chamber. Using the thermocatalytic chamber and at least a portion of the thermal energy in the fluid stream, a thermal process is executed on an introduced processable material while maintaining submersion of the thermocatalytic chamber in a liquid to control temperature of the thermocatalytic chamber. This process produces a stream of processed/exhaust gases (which can contain entrained solid(s) and liquid(s)) that exit the thermocatalytic chamber. The stream of processed/exhaust gases is passed through a diffuser, that is also submerged in the liquid, to form the stream into bubbles discharged by the diffuser into the liquid. Upstream of the diffuser, flow of the processed/exhaust gases is directed through a dry loop that is also submerged in the liquid but at a level higher than the level of the thermocatalytic chamber to prevent upstream incursion of the liquid into the thermocatalytic and flame chambers.

Exemplary thermal processes that can be performed include, but are not limited to, evaporation, condensation, vapor processing, energy recovery, solute removal, concentration, consolidation, gas generation, combustion, purification, phase change, chemical reaction, and material conversion. These processes can be performed at any of various sites and circumstances using the apparatus that is readily transportable substantially anywhere and that is capable of combusting any of various combustibles (including but not limited to waste combustibles) that may be available at the site. The apparatus and methods are operable at very high efficiency and provide a wide range of thermal conditions that can be selectively exploited in performing one or more thermal processes. Multiple thermal processes, such as processes requiring different respective temperatures, can be performed simultaneously.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic diagram of an embodiment of a thermal processing apparatus.

FIG. 2 is a perspective elevational section (with a front portion of the tank removed to show detail) of an embodiment of the thermal processing apparatus.

FIG. 3(A) is a perspective view of a portion of an exemplary configuration of a processed/exhaust gas diffuser usable, for example, in the embodiment of FIG. 2.

FIG. 3(B) is a sectional end view of the processed/exhaust diffuser of FIG. 3(A).

FIG. 4 is a perspective view (with tank removed) of an embodiment of a thermal processing apparatus comprising two processing assemblies.

FIG. 5 depicts a portion of the primary thermocatalytic chamber in which is situated a vaporization chamber for conducting a thermal process on a processable material introduced into the vaporization chamber.

FIG. 6 depicts a portion of the primary thermocatalytic chamber in which is situated a boiler and a process chamber, wherein the boiler produces superheated steam for introduction into the primary thermocatalytic chamber, and the process chamber performs a thermal process on processable material introduced into the process chamber.

FIG. 7 depicts a portion of the primary thermocatalytic chamber that comprises vortexing fins for creating a vortex flow through the primary thermocatalytic chamber.

FIG. 8 depicts a portion of the primary thermocatalytic chamber in which is situated multiple reaction chambers; also shown are reaction chambers situated outside but contacting the primary thermocatalytic chamber.

### DETAILED DESCRIPTION

The subject apparatus and methods are described in the context of representative embodiments that are not intended to be limiting in any way.

In the following description, certain terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

### First Representative Embodiment

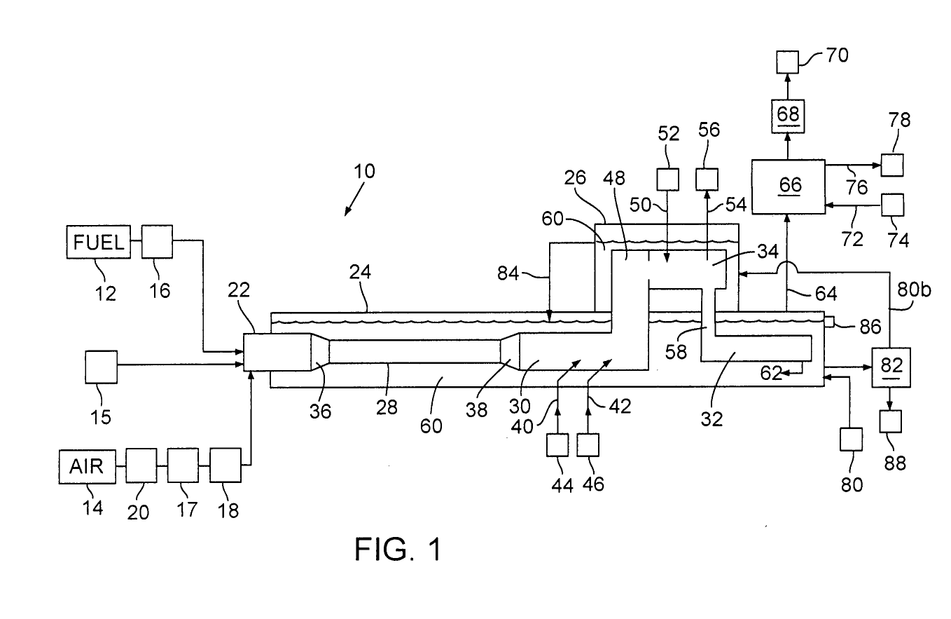

General aspects of a first representative embodiment of a thermal processor 10 are shown in FIG. 1. The thermal processor 10 of this embodiment combusts a suitable fuel 12 in the presence of air or oxygen 14 (generally termed “air”) to produce heat. Alternatively or in addition, heat can be supplied to the thermal processor 10 from an extraneous source 15 such as a combustion-exhaust stream (e.g., flue gas or turbine exhaust) and/or from the capture and use of any of various oxidizers. The heat is used to drive the thermal processor 10 as well as any of various processes and apparatus that can be performed in it or while using it.

For combustion of the fuel 12, the thermal processor 10 comprises a fuel controller 16 that controllably delivers a stream of fuel 12, an air blower 17 or the like that moves air, and an air controller 18 (e.g., vane or valve) that controllably delivers a stream of air 14 at a desired flow rate and volume. The fuel 12 can be any readily combustible substance, desirably a gaseous substance such as natural gas or a component of natural gas. The fuel 12 need not be pure; it can be a mixture of fuels (e.g., two or more hydrocarbon gases) and can include any of various substances that ordinarily would be considered “waste” substances, such as gaseous effluents from a well. The “air” 14 is most conveniently obtained from the ambient atmosphere, but alternatively can be obtained from a compressed air source or other source of an oxidizing gas (e.g., containing sufficient oxygen) to support combustion of the fuel 12. Desirably, the air 14 is cleaned of larger particulates and the like by a filter 20 located upstream of the blower 17. The blower 17 and air controller 18 deliver air at an appropriate (typically constant) and controlled flow rate and volume to support combustion. The air and fuel come together at high velocity (desirably in a vortexed manner) in a combustion head 22 in which the air 14 and fuel 12 commence burning. The resulting combustion produces a substantial flame that produces a high-velocity stream of very hot exhaust gases. The flame extends from the combustion head 22 into a “flame chamber” 28.

The apparatus 10 also comprises a first liquid-processing chamber 24 and a second liquid-processing chamber 26. Situated in the first liquid-processing chamber 24 are a portion of the combustion head 22 as well as the flame chamber 28, a “primary thermocatalytic” (also called “first thermocatalytic”) chamber 30, and a processed/exhaust gas diffuser 32. Situated in the second liquid-processing chamber 26 is a “secondary thermocatalytic” (also called “second thermocatalytic”) chamber 34. Liquid (usually water) contained in the first liquid-processing chamber 24 completely surrounds the portion of the combustion head 22 located in the first liquid-processing chamber 24 and also surrounds the flame chamber 28, the primary thermocatalytic chamber 30, and the processed/exhaust gas diffuser 32. Liquid (usually water) contained in the second liquid-processing chamber 26 completely surrounds the secondary thermocatalytic chamber 34. The liquid keeps the wall temperatures of the chambers 22, 28, 30, 32, 34 substantially constant.

As noted, the flame chamber 28 receives and contains the flame from the combustion head 22. Due to the high velocity of air 14 and fuel 12 entering the combustion head 22, the flame extends substantially the full length of the flame chamber 28. As noted, the flame produces a voluminous and high-velocity stream of extremely hot “exhaust” gases. The fuel controller 16, blower 17, and air controller 18 regulate delivery of fuel 12 and air 14 to the combustion head 22 in a manner that maintains the length of the flame coextensively with the length of the flame chamber 28 (without extending beyond the flame chamber) and that achieves the most complete obtainable combustion of the fuel. An exemplary manner for the air controller 18 to achieve regulation of air flow is by adjustment of the opening of a butterfly valve or the like in a duct delivering air from the blower 17 to the combustion head 22.

The interior of the flame chamber 28 is extremely hot. As a result of the temperature differential between the interior of the flame chamber and the liquid contained in the first liquid-processing chamber 24, heat-transfer occurs across the wall of the flame chamber 28 to the liquid.

The exhaust gases produced in the flame chamber 28 enter the primary thermocatalytic chamber 30 in which the thermal energy of the exhaust gases can be captured and utilized in at least one process. The primary thermocatalytic chamber 30 begins downstream of the flame chamber 28 and thus downstream of the flame. Hence, the thermocatalytic chamber 30 is, in effect, indirectly heated (not by direct contact with the flame).

It is desirable that characteristics of the flame (e.g., flame length and temperature) in the flame chamber 28 be monitored using appropriate sensors (not shown), such as temperature sensor(s) placed strategically along the length of the chamber and/or at least one oxygen sensor. The sensor(s) can be used in a feed-back control manner (microprocessor-controlled is desirable) to control supply of fuel 12 and air 14 to the combustion head 22, thereby keeping the flame at a proper temperature and length for maximal heat production and the most efficient combustion. Avoiding excessively “rich” or “lean” combustion can also be advantageous in preventing production or accumulation, under certain conditions, of potentially explosive or otherwise dangerous products or mixtures.

By way of example, in an embodiment of the thermal processor 10 using natural gas as a fuel, the temperature of the exhaust gases entering the primary thermocatalytic chamber 30 is approximately 3800° F. At least a portion of this heat can be exploited for use in performing at least one thermal process in the primary thermocatalytic chamber 30. For thermal-processing purposes, the primary thermocatalytic chamber 30 can receive one or more respective streams 40, 42 of thermally processable material 44, 46 (e.g., combustible waste material, thermally convertible material, material requiring evaporation, dehydration, etc.). For high-efficiency processing, the material 44, 46 can be in a form (e.g., gaseous, liquid, or particulate suspension) in which it can be entrained in the high-velocity flow of exhaust gases and exothermally reacted upon and processed to provide an additional source of heat. By entering the primary thermocatalytic chamber 30 rather than the flame chamber 28, the material 44, 46 can be thermally processed in a flame-less environment, in contrast to conventional thermal processors, thereby avoiding the fouling problems typically encountered in conventional systems in which processable material is introduced directly into a flame. In the high-heat environment in the primary thermocatalytic chamber 30, the material 44, 46 is thermally processed such as evaporated, dried, thermally converted, reacted, or the like (depending upon the particular material). In addition, heat exchange occurs across the wall of the primary thermocatalytic chamber 34 to the liquid 60 in the first liquid-processing chamber 24.

Introduction of processable material 44, 46 into the primary thermocatalytic chamber 30 can be performed by respective pumps (not shown) on each of the lines 40, 42. Alternatively, it is possible that the respective supplies of processable material 44, 46 may already be pressurized sufficiently for introduction. Yet another way in which to introduce the processable material 44, 46 is to provide the primary thermocatalytic chamber 30 with a venturi or the like operable to aspirate the material into the chamber.

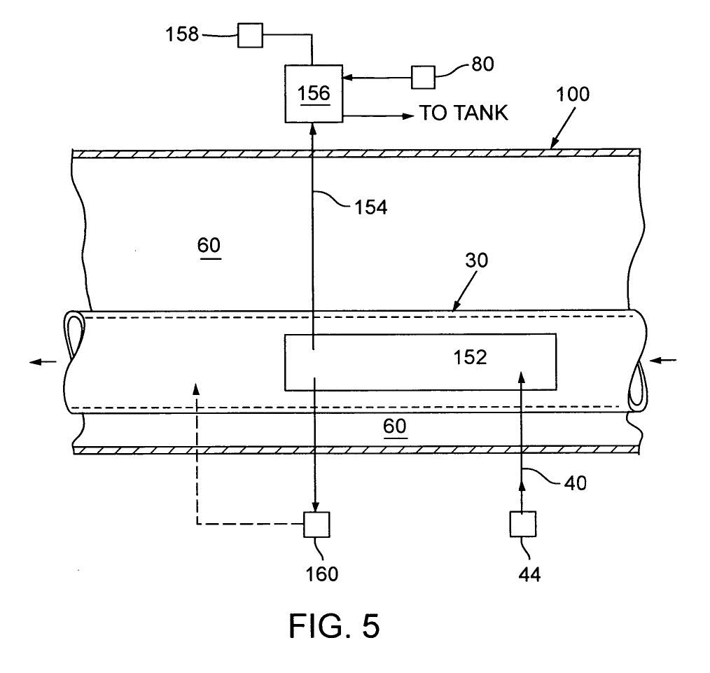

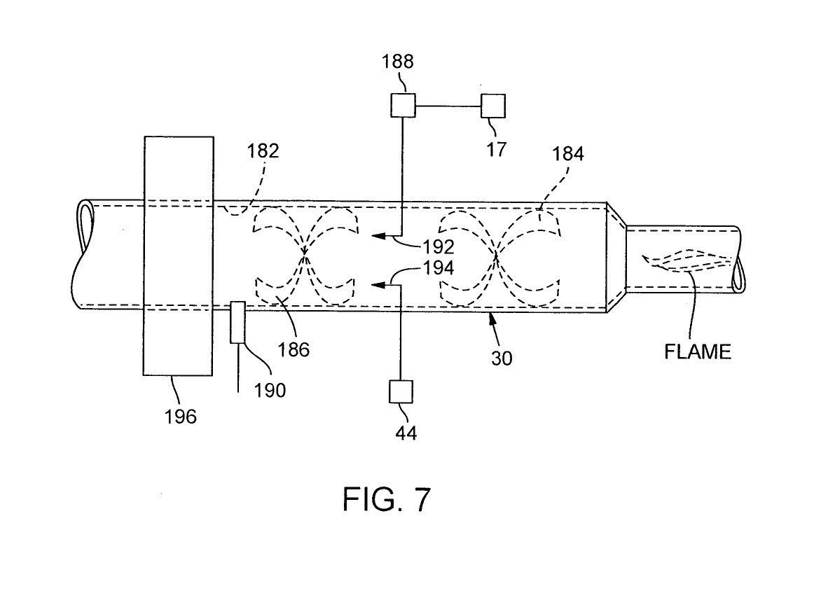

As discussed further later below, for processing purposes, the primary thermocatalytic chamber 30 can have any of various “accessories” (chambers, flow-directors, grids, tubes, baffles, compartments, and the like) used for performing the desired thermal process on the introduced processable material. If, for example, the accessory is a process chamber located inside the primary thermocatalytic chamber, then the processable material can be introduced through the wall of the thermocatalytic chamber into the process chamber. An example configuration is depicted in FIG. 7. If, for example, the accessory is a process chamber located inside the primary thermocatalytic chamber 30, then the processable material can be introduced through the wall or end of the thermocatalytic chamber into the process chamber. Alternatively or in addition, one or more accessories (e.g., coils, tubes, conduits, heat-exchangers, etc.) may be situated in the primary thermocatalytic chamber 30 to perform endothermic processing of other materials or to be used to capture and transfer heat. These accessories can be “staged” to produce high-temperature and/or high-pressure processes. The general concept is depicted in, e.g., FIG. 5:

The primary thermocatalytic chamber 30 desirably includes one or more sensors (not shown but well understood in the art) useful for monitoring conditions inside the chamber for optimal processing. Exemplary sensors are temperature sensor(s), pressure sensors, and oxygen sensor(s). The sensors desirably are connected in a manner providing feedback control (via a microprocessor or analogous device) to the flow of processable material 44, 46 into the primary thermocatalytic chamber 30. For example, feedback from the sensor(s) can be used to control the rate of delivery (e.g., pump rate) of the processable material 44, 46.

Effluent from the primary thermocatalytic chamber 30 includes the exhaust gases and any processed gases (now potentially at a lower temperature than in the flame chamber 28 or at the entrance of the primary thermocatalytic chamber), heat that may have been produced in the primary thermocatalytic chamber if thermal processing of the material 44, 46 was exothermic, products and by-products of the thermal processing, and possibly residual unprocessed material. This effluent can be delivered 48 to the secondary thermocatalytic chamber 34. The secondary thermocatalytic chamber 34, contained in the second liquid-processing chamber 26 in this embodiment, is associated with a “dry loop” situated between the primary thermocatalytic chamber 30 and the processed/exhaust gas diffuser 32. The dry loop prevents back-flow of liquid from the first and second liquid-processing chambers 24, 26 into the primary and secondary thermocatalytic chambers 30, 34, the flame chamber 28, and the combustion head 22. The secondary thermocatalytic chamber 34 can receive, for thermal processing purposes, at least one stream 50 of processable material 52 (e.g., water for producing steam). Since the interior of the secondary thermocatalytic chamber 34 is potentially at a lower temperature than the interior of the primary thermocatalytic chamber 30, the thermal process conducted in the secondary thermocatalytic chamber can be one that requires a lower temperature than the process(es) conducted in the primary thermocatalytic chamber. Thermal processing in the secondary thermocatalytic chamber 34 produces a stream 56 of processed material that can be either left in the stream passing through the secondary thermocatalytic chamber or separately collected (e.g., steam) for utilization elsewhere. Also, thermal transfer occurs across the walls of the secondary thermocatalytic chamber 34 from the interior of the secondary thermocatalytic chamber to the liquid 60.

Effluent 58 (including residual heat and entrained matter) from the secondary thermocatalytic chamber 34 enters the processed/exhaust gas diffuser 32. As discussed further below, the processed/exhaust gas diffuser 32 desirably is configured as a conduit (submerged in the liquid in the first liquid-processing chamber 24) having walls perforated with multiple apertures. Desirably, the apertures are in the lower walls of the processed/exhaust gas diffuser 32 and can be round or slotted, for example. The processed/exhaust gas diffuser 32 is configured such that substantially all the effluent 58 (gaseous components as well as solids 62 and/or liquids entrained in the gaseous components) exits the processed/exhaust gas diffuser 32 via the apertures into the liquid 60. The discharged gaseous components rise as bubbles 64 in the liquid 60. The bubbles 64 release heat and some of their contents into the liquid 60. Some of the other contents of the bubbles 64 are released into the atmosphere 66 in the first liquid-processing chamber 24 above the level of the liquid 60. Thus, thermal exchange occurs not only across the walls of the flame chamber 28, thermocatalytic chambers 30, 34, and processed/exhaust gas diffuser 32 to the liquid 60 but also directly between the bubbles 64 and the liquid 60.

The atmosphere 66 can be circulated as required through a cleaner/separator 68 to remove selected gases, liquids, and/or entrained solids, and then discharged via a stack or flue 70 or used for a purpose (e.g., injection into a well). By way of example, the cleaner/separator 68 can be a de-mister and/or vapor condenser. If desired, the chamber atmosphere 66 can receive at least one stream 72 of processable material 74 (e.g., water for heating). Processing produces a stream 76 of processed material 78 (e.g., hot water). Also, as discussed elsewhere, the atmosphere 66 is substantially saturated with water vapor that can be condensed (e.g., as a continuous operation during operation of the apparatus) and used.

Liquid is kept at a desired level in the first and second liquid-processing chambers 24, 26 by a liquid supply 80. The liquid supply 80 can be pressurized, as in a municipal water supply, for example, or can be a natural supply. A pump can be used, if necessary, to urge flow of liquid from a natural source. The first liquid-processing chamber 24 desirably has a depth monitor 86 (e.g., an electrical sight tube, contact sensors, etc.) to ensure that the liquid level in the first liquid-processing chamber remains substantially constant at a desired level. (For safety purposes, it is desirable to use multiple, desirably at least five, depth monitors 86.) In this embodiment, liquid 60 in the first liquid-processing chamber 24 is circulated 80a, 80b to the second liquid-processing chamber 26, and liquid returns to the first liquid-processing chamber to the second liquid-processing chamber via a drain 84 that establishes and controls the depth of liquid in the second liquid-processing chamber. Thus, the respective liquid levels in the first and second liquid-processing chambers 24, 26 remain substantially constant. The circulation 80a, 80b can include passage of the liquid through a separator 82 or the like (e.g., a filter or precipitator for removing solids 88 and/or solid-forming materials from the liquid). Desirably, the separator 82 is used continuously, with constant liquid recirculation.

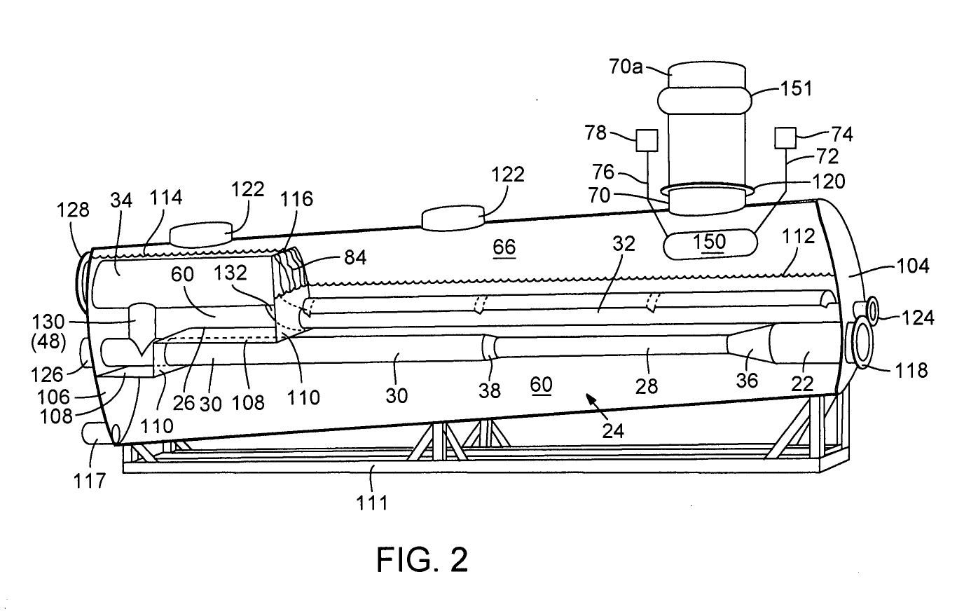

Reference is now made to FIG. 2, depicting other features of this embodiment. The thermal processor 10 of this embodiment comprises an axially (longitudinally) extended tank 100 or analogous vessel having cylindrical walls 102, a first end 104, and a second end 106. (It will be understood that the stated cylindrical configuration of the walls is not intended to be limiting; the tank or vessel in other embodiments may have any practical shape such as any of various rectilinear shapes. Cylindrical is desirable because of its ease of manufacture and high strength.) The tank 100 desirably is made of a durable metal that is resistant to oxidation, such as polished 304 stainless steel, 10-gauge thickness. An exemplary size of the tank 100 is 20 feet long and 5 feet in diameter. Most of the interior of the tank 100 defines the first liquid-processing chamber 24. The second liquid-processing chamber 26 is also situated in the tank 100 but is partitioned from the first liquid-processing chamber 24 by walls 108, 110 (also desirably made of 304 stainless steel, 10-gauge thickness). The tank 100 is supported by a frame 111 or analogous supporting structure made of stainless steel, mild steel, or other suitable material. The tank 100 can be insulated (not shown) if desired, or alternatively left uninsulated. The frame 111 can be provided with wheels (not shown) or the like for transportability, or can be mounted to or placed on a motor vehicle (e.g., a truck or trailer) for transport.

During use, the first liquid-processing chamber 24 contains liquid 60 at a defined and controlled level 112 that does not completely fill the first liquid-processing chamber. Similarly, the second liquid-processing chamber 26 contains liquid 60 filling the second liquid-processing chamber to a specified and controlled level 114. The level 114 in the second liquid-processing chamber 26 is determined by the height of an upper lip 116 of the wall 110. The lip 116 provides a spillway for liquid flow from the second liquid-processing chamber 26 into the first liquid-processing chamber 24, and thus defines the “drain” 84 shown schematically in FIG. 1. The level 112 of the liquid in the first liquid-processing chamber 24 is determined by a level sensor that is operatively coupled to a pump, or other flow device, as previously described.

The flame tube 28, at least the proximal portion of the primary thermocatalytic chamber 30, and the processed/exhaust gas diffuser 32 are situated in the first liquid-processing chamber 24 below the liquid level 112 therein. Also situated below the liquid level 112 in the first liquid-processing chamber 24 is a portion of the combustion head 22. The secondary thermocatalytic chamber 34 is situated in the second liquid-processing chamber 26 below the liquid level 114 therein. The distal portion of the primary thermocatalytic chamber 30 may be situated below the secondary thermocatalytic chamber 34 within the second liquid-processing chamber 26, or it may be situated outside and below the second liquid-processing chamber within the first liquid-processing chamber 24. The liquid level 114 is higher than the liquid level 112, as established by the height of the lip 116 over which liquid flows from the second liquid-processing chamber 26 to the first liquid-processing chamber 24. The liquid level 112 is maintained below the lowest portion of the secondary thermocatalytic chamber 34 to maintain the “dry-loop” effect inside the thermocatalytic chambers 30, 34.

The tank 100 is mounted on the frame 111 such that the first end 104 is approximately 12″ higher than the second end 106. The components 22, 28, 30, 32, and 34 inside the tank 100 are substantially horizontal, however. The tilt of the outer tank 100 facilitates movement of solids toward the second end 106, allowing convenient removal of the solids, as desired or required, through a removal port 117 (normally closed during operation) extending through the second end.

The tank 100 also defines the stack 70 through which the atmosphere 66 can be released. As noted above, before discharge, the atmosphere 66 can be passed or circulated as required through a cleaner/separator 68 (e.g., a demister and/or condenser, not shown in FIG. 2) to remove selected gases, liquids, and/or entrained solids from the atmosphere. In such a configuration at least a portion of the cleaner/separator 68 can be located inside the tank 100, such as below the stack 70. Alternatively, the stack 70 can be provided with a flange 120, as shown, or the like for mounting a cleaner/separator outside the tank 100. By way of example, the atmosphere 66 typically is substantially saturated with water vapor, and the water can be collected by circulating the atmosphere through a condenser (as a portion of the cleaner 68) for collection and use elsewhere or in the apparatus itself. Desirably, the atmosphere 66 exiting the stack 70 is monitored. For example, at least one oxygen sensor (not shown) can be mounted to monitor the oxygen concentration in the atmosphere 66. Data from the sensor can be used in a feedback-control circuit (using a microprocessor, for example) controlling conditions of combustion and/or processing being conducted in the apparatus 10.

The tank 100 also can be provided with one or more ports 122 (normally closed during operation) through which a person can enter the tank for maintenance, inspection, testing, installation, or cleaning purposes, for example. One or more of the ports 122 also can be utilized to provide access into the tank of any of various devices such as sensor probes, test equipment, imaging equipment, and process accessories, for example. The tank 100 can include other ports, as desired or required, for cleaning, maintenance, sensor placement, installing accessories, or the like. For example, the distal end of the processed/exhaust gas diffuser 32, actually extending outside the first end 104, desirably includes a port 124 (normally kept closed). Also, the distal end of the primary thermocatalytic chamber 30 desirably includes a port 126 at the distal end of the processed/exhaust gas diffuser 32, and the secondary thermocatalytic chamber 34 desirably includes a port 128. The ports 126, 128 extend through the second end 106 to outside the tank 100 and are normally closed during operation.

The combustion head 22 extends through the first end 104 from outside the tank 100 to inside the first liquid-processing chamber 24 below the liquid level 112. Outside the tank, the combustion head 22 includes a flange 118 or the like to which the blower 17, air controller 18, and fuel controller 16 (see FIG. 1) are mounted. The combustion head 22 comprises a burner assembly (not detailed) that produces a powerful vortex of the air-fuel mixture while thoroughly mixing the air and fuel, in the manner of an oil-burning head on an oil furnace, for example. To such end, the fuel 12 desirably enters the end of the combustion head 22, and the air (or other oxidizing gas) 14 desirably enters the combustion head from the side, as shown in FIG. 1. Typically, especially in larger units, the fuel 12 is discharged from the combustion head 22 from multiple orifices into the air vortex. The combustion head 22 also includes at least one ignition source such as a pilot light, piezoelectric igniter, spark plug, glow plug, or the like. In many instances, combustion is self-sustaining after commencement. Actual combustion is manifest as a powerful jet of combustion flame that extends from the combustion head 22 down the length of (but contained within) the flame chamber 28. As a result of powerful air-fuel vortexing achieved by the combustion head 22 and the high velocity of air produced by the blower, the flame in the flame chamber 28 is tightly formed, with a long axial length and relatively small diameter.

The combustion head 22 and flame chamber 28 are distinctive because, despite being submerged in the liquid 60, they are substantially horizontal, in contrast to the substantially vertical configuration of most conventional types of submerged combustors. Thus, with this embodiment, substantially less energy is expended in combustion and forming the flame in the desired manner, which yields corresponding increases in thermal transfer and overall efficiency.

As shown in FIG. 2, the flame chamber 28 desirably has a smaller diameter (transverse dimension) than the combustion head 22. The relatively small diameter of the flame chamber 28 facilitates preservation of the longitudinally extended and narrow configuration of the vortexed flame, ensuring that the flame is substantially coextensive with the length of the flame chamber. For example, in one embodiment, the flame chamber 28 has a diameter of six inches, compared to at least twelve inches diameter of the combustion head 22. Connection between the combustion head 22 and the flame chamber 28 desirably is made using a frustoconical coupling 36 as shown. By way of example, the flame chamber 28 has a length of six feet.

The primary thermocatalytic chamber 30 in this embodiment has a larger diameter (transverse dimension) than the flame chamber 28. Thus, the coupling 38 between the flame chamber 28 and primary thermocatalytic chamber 30 desirably has a frustoconical configuration, or analogous configuration, in the manner of an expander. By way of example, the flame chamber 28 has a diameter of six inches, and the primary thermocatalytic chamber 30 has a diameter of eight inches and a length of eight feet. The expanded diameter of the primary thermocatalytic chamber 30 relative to the flame chamber 28 yields more complete thermal transfer from the exhaust gases to the thermally processable material 44, 46 and/or to a processing medium introduced into or present in the primary thermocatalytic chamber.

If desired or required, the inside walls of the primary thermocatalytic chamber 30 can be provided with fins, vanes, baffles, or the like to facilitate production of a desired flow dynamic of exhaust gases and any processable and processed gases and other material through the primary thermocatalytic chamber. For example, vanes can be installed to facilitate vortexed propagation of processed and exhaust gases, as discussed later below.

As noted, the distal portion of the primary thermocatalytic chamber 30 can either extend through the wall 110 into the second liquid-processing chamber 26 and through the second end 106 of the tank 100 to the port 126, or pass below the second liquid-processing chamber and extend through the second end 106 of the tank 100 to the port 126. A conduit 130 carries effluent 48 from the primary thermocatalytic chamber 30 upward to the proximal end of the secondary thermocatalytic chamber 34, which is located in the second liquid-processing chamber 26. The conduit 130 may have a diameter that is substantially equal to or greater than the diameter of the primary thermocatalytic chamber 30 to change the flow rates and pressures to the secondary thermocatalytic chamber 34. The secondary thermocatalytic chamber 34 desirably has a diameter substantially equal to or greater than the diameter of the primary thermocatalytic chamber. Thus, as processed and exhaust gases propagate through the primary thermocatalytic chamber 30, the conduit 130, and the secondary thermocatalytic chamber 34, the velocity of the processed and exhaust gases can be progressively reduced.

The distal end of the secondary thermocatalytic chamber 34 is connected to a conduit 132 that extends from the second liquid-processing chamber 26 through the wall 110 into the first liquid-processing chamber 24 and is coupled to the proximal end of the processed/exhaust gas diffuser 32. The processed/exhaust gas diffuser 32 extends from the wall 110 to the first end 104 of the tank 100. The distal end of the processed/exhaust gas diffuser 32 extends through the first end 104 to the port 124.

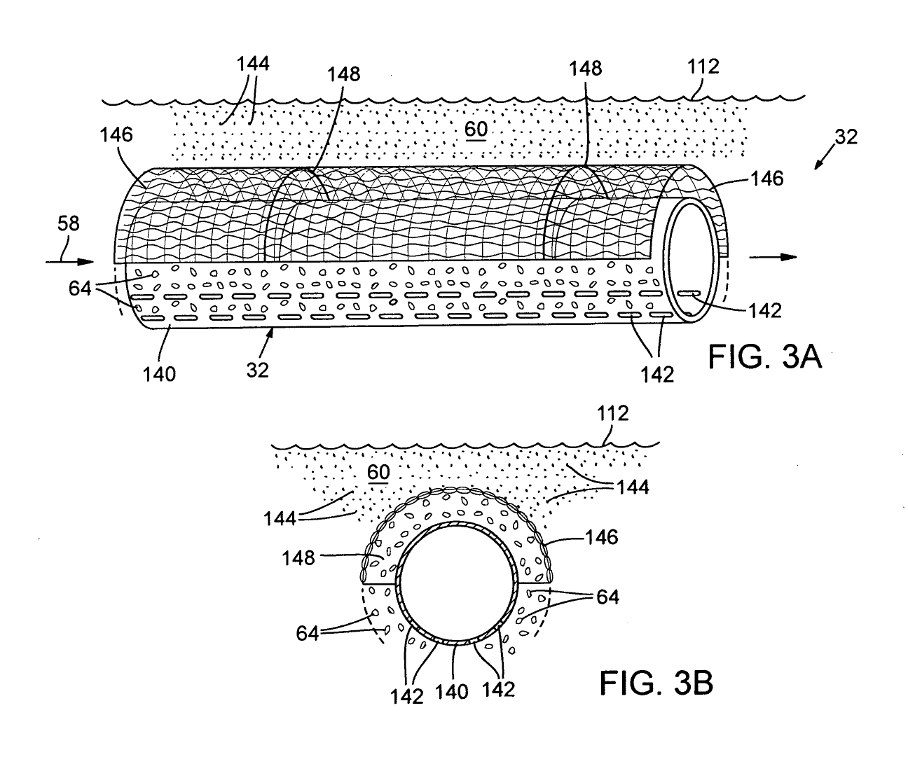

An exemplary processed/exhaust gas diffuser 32 has a configuration as shown in FIG. 3(A), depicting a portion of the length thereof. The processed/exhaust gas diffuser 32 comprises a longitudinally extended diffuser tube 140 that defines, along its lower wall, arrays of diffuser apertures 142 through which gaseous effluent (processable effluent 58) passes from inside the processed/exhaust gas diffuser 32 to the surrounding liquid 60 in the first liquid-processing chamber 24. The diffuser apertures 142 desirably are longitudinal slits as shown, but alternatively can be round or any other appropriate shape, or combination of shapes. As the gaseous effluent 58 exits the diffuser apertures 142, relatively large bubbles 64 are formed, each containing a respective volume of gaseous effluent (which can include entrained solids and/or liquids). To break up the large bubbles 64, a “diffuser screen” 146 or other perforated member is positioned, on spacers 148 or the like, above the upper surface of the diffuser tube 140 and at least partially surrounding the diffuser tube 140. Referring to FIG. 3(B), as the relatively large bubbles 64 encounter and pass through the diffuser screen 146, they break up into relatively small bubbles 144 that continue to rise in the liquid 60. To facilitate break-up of bubbles, the diffuser screen 146 desirably has an appropriate “mesh” size, such as ¼ inch. The small bubbles 144 present a larger surface area, relative to their respective volumes, than the larger bubbles 64. Thus, the smaller bubbles 144 provide increased efficiency with which the liquid 60 can perform “scrubbing,” namely, remove solids, solutes, gases, and other substances from the effluent 58. The diffuser screen 146 and the location of the diffuser apertures 142 on the lower wall of the diffuser tube 140 facilitate separation of particles from the processed/exhaust gas stream and collection of the particles in the liquid 60.

The high-temperature gases flowing at high velocity through the flame chamber 28, the primary thermocatalytic chamber 30, and the secondary thermocatalytic chamber 34 contain and produce ionic species that tend to have an anodic property and tend to impart that property to these chambers. If the liquid 60 comprises mostly water, it typically behaves as an electrolytic solution due to its absorption of substances such as carbonates and sulfur compounds from the bubbles. As a result, the liquid 60 (and hence the processed/exhaust diffuser 32 and the tank 100) tends to exhibit a cathodic property. The anodic property (produced by the gases) and the cathodic property (produced by the liquid) tend to produce a balance of charge in the overall apparatus, which desirably is electrically grounded. Even though the anodic and cathodic properties can cause plating reactions that result in formation of oxide layers on the various chambers and conduits, the overall charge balance tends to limit these reactions. As a result, the oxide layers tend to be self-limiting with respect to accumulation and with respect to metal loss. In addition, the presence of both anodic and cathodic properties in the apparatus yields a general charge balance in the apparatus. The charge balance produces an overall buffering effect that inhibits runaway changes in pH of the liquid 60 and inhibits progressive corrosion of the apparatus.

Despite being beneath the liquid level 114 in the second liquid-processing chamber 26, the conduit 130, the secondary thermocatalytic chamber 34, and the conduit 132 form a “dry loop,” of which the interior contains substantially no liquid, even though the processed/exhaust gas diffuser 32 is open (via the apertures 142) to the liquid 60 in the first liquid-processing chamber 24. The dry loop also prevents liquid incursion into the primary and secondary thermocatalytic chambers 30, 34, flame chamber 28, and combustion head 22. Prevention of liquid flow into and upstream of the dry loop is achieved in part by the substantial pressure of exhaust gases flowing through it, and in part from the lowest portion of the secondary thermocatalytic chamber 34 being situated above the liquid level 112 in the first liquid-processing chamber 24.

In the first liquid-processing chamber 24, in the atmosphere 66 above the surface of the liquid 60, can be placed any of various process devices 150 for performing one or more of the following: (a) executing a process on a processable material 74 utilizing the heat in the atmosphere 66 (e.g., using heat to convert the processable material 74 into a desired processed material 78), (b) executing a process on one or more substances in the atmosphere 66 utilizing the heat in the atmosphere 66 (e.g., using heat to convert the one or more substances into a less toxic or more useful material), (c) removing at least one substance in the atmosphere 66, and (d) performing a phase change on a processable material 74 (e.g., converting the material from a solid into a liquid or from a liquid into a vapor). Exemplary devices include, but are not limited to, a heater for water or other liquid, a vaporizer, a condenser, a thermocatalytic converter, a drier, a melter, a sublimator, a dehydrator, etc. Thus, the process device 150 can be or can include the cleaner/separator 68 discussed above. Alternatively to placing the process device 150 inside the atmosphere 66, a process device 151 can be coupled to the stack 70 and utilized by flowing the atmosphere 66 out the stack and through the process device 151. For example, the device 151 can be a condenser for continuously condensing water vapor and/or other vapors in the atmosphere 66 exiting the stack. Thus dehydrated atmosphere exits an “upper” stack 70a.

### Second Representative Embodiment

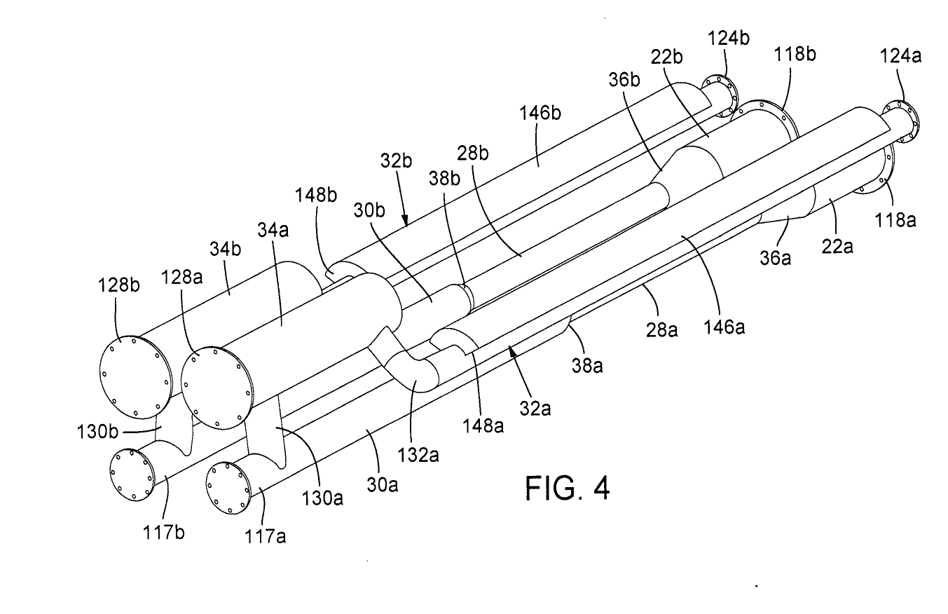

The second representative embodiment is similar to the first representative embodiment, except that the tank 100 contains first and second combustion heads 22a, 22b, first and second flame tubes 28a, 28b, first and second primary thermocatalytic chambers 30a, 30b, first and second secondary thermocatalytic chambers 34a, 34b, and first and second processed/exhaust gas diffusers 32a, 32b. See FIG. 4, which depicts these components but with the tank removed for clarity.

The embodiment of FIG. 4 can be used in parallel or in series. Use in parallel can provide twice the output of energy and processed material than the embodiment of FIG. 2. For parallel use, fuel flow from the fuel controller 16 and air flow from the blower 117 can be split so as to enter the first and second combustion heads 22a, 22b simultaneously. In series, the output from one assembly can be directed into the other assembly.

Combustion

As discussed above, the various apparatus embodiments can be supplied with heat, for performing any of various processes, by combustion of fuel 12. The fuel 12 can be any of various combustible fuels, including, but not limited to, natural gas, purified gas (e.g., methane, propane, and/or butane), well-gas, liquid hydrocarbon fuel, biogas, etc. The liquid hydrocarbon fuel can be, but is not limited to, a high-grade fuel or a low-grade fuel, or a mixture thereof. Exemplary high-grade fuels are commercial natural gas, gasoline, kerosene, alcohol, and purified hydrocarbons. Exemplary low-grade fuels are any of various hydrocarbons, hydrocarbon mixtures, etc., from petroleum wells, industrial byproducts, and the like, usually containing significant amounts (or substantial amounts) of contamination such as water. Importantly, the fuel 12 can be an indigenous fuel at a particular site, such as well-gas at a remote oil-well site, biogas, waste-gas or flare-gas at an industrial site, waste-recovery site, mine site, or the like, and can be a fuel that otherwise would be discarded or combusted without energy recovery in conventional situations. In other words, an available fuel at a site can be used “as-is” rather than be discarded or wastefully burned simply because it is unfit for any practical conventional use.

If a particular low-grade fuel at a particular site is excessively laden with contamination, a higher-grade fuel can be used to supply the combustion head and the lower-grade the fuel can be injected downstream of the combustion head. Alternatively, the low-grade fuel can be mixed with a higher-grade fuel before introduction to the combustion head. Furthermore, certain contaminated low-grade fuels may be relieved of at least some of their contaminant load (e.g., water) by processing using the current apparatus to provide a fuel that can be satisfactorily combusted at the combustion head.

In addition to or alternatively to supplying the apparatus with fuel for combustion to produce heat, the apparatus can be provided with heat from an extraneous heat source 15. The extraneous heat source 15 can be, for example, flue gas from a separate combustor or engine, exhaust gas from a turbine, heat produced by a separate processor such as an exothermic reactor, or any of various other heat sources.

Thermocatalytic Processing

In the primary and secondary thermocatalytic chambers heat can be recovered, from the hot exhaust gases exiting the flame chamber, for use in one or more processes performed in or in association with the thermocatalytic chambers. For example, such a process can be performed in a device inserted into the primary thermocatalytic chamber or a device in thermal contact with the primary thermocatalytic chamber. A device in thermal contact may be a device located outside the thermocatalytic chamber, as discussed later below.

The mean temperature in the primary thermocatalytic chamber is potentially higher than in the secondary thermocatalytic chamber, which allows different respective processes to be performed in the primary and secondary thermocatalytic chambers (i.e., higher-heat process(es) in the primary thermocatalytic chamber, and lower-heat process(es) in the secondary thermocatalytic chamber). As discussed above, the thermocatalytic chambers are submerged in liquid and have respective walls that are in contact with liquid in the tank. Consequently, as the exhaust gases propagate downstream through the primary and secondary thermocatalytic chambers, the gases progressively cool. The resulting temperature profile provides multiple temperature levels that can be selected for performing various processes. If a particular process requires a particular temperature for execution, the location in or on the thermocatalytic chamber at which that particular temperature is available is readily selected. Since there is generally a progressive decline in temperature in the primary thermocatalytic chamber (as well as in the secondary thermocatalytic chamber), a higher-temperature process can be performed in the proximal portion of the primary thermocatalytic chamber, for example, and a lower-temperature process can be performed in the distal portion of the primary thermocatalytic chamber. In any event, thermal transfer from the exhaust gases to processable materials in the thermocatalytic chambers is highly efficient.

An example process is evaporation of a processable material to remove a volatile component of the material, reduce mass or volume of the material, change the concentration of the material, distill a material, thermally convert a material, or otherwise process the material for more practical, or safer, use or transport. Example processable materials in this regard, among a very large number of candidate materials, are wastewaters and sludges of many kinds, waste antifreezes and de-icers, any of various materials containing volatile liquid, hydrated oils, solute- or particulate-laden fluids, etc. Referring, for example, to FIG. 5, a thermally processable material 44 is introduced through the wall of the tank 100, through the wall of the primary thermocatalytic chamber 30 and into a vaporization chamber or conduit 152 situated in the primary thermocatalytic chamber. The walls of the vaporization chamber 152 can include surface-area-increasing features such as fins, baffles, undulations, or the like (not shown) to increase the surface-area contact with the exhaust gases. As the processable material 44 passes through the vaporization chamber 152, volatile components of the material are evaporated, and the vapor exits via a conduit 154 from the vaporization chamber 152 and from the primary thermocatalytic chamber 30. The exiting vapor can be routed through a condenser 156 or the like for condensation and recovery 158 for a practical use. The condenser 156 can be configured to utilize, for condensation purposes, liquid (e.g., water) from the same supply 80 used for supplying liquid to the tank 100, for example. An exemplary processable material 44 in this regard is waste water containing solutes and/or suspended material that should be removed to render the water useful. The recovered condensed water 158 can be used for any of various practical uses, which can include potable and/or agricultural use. Meanwhile, non-volatiles 160 (which can include other gases) are recovered. If desired or required, the non-volatiles 160 can be introduced 162 into the primary thermocatalytic chamber 30 for further processing. Combustible material released from the processing can be routed back to a thermocatalytic chamber (e.g., first thermocatalytic chamber 30) or otherwise introduced into the flame chamber 28 for combustion or additional processing.

Alternatively, vaporization and the like can be performed for some materials by introducing the processable material 44 directly into the primary thermocatalytic chamber 30. In the chamber 30, the processable material 44 is directly contacted by the exhaust and processed gases (which are at very high temperature and are flowing at high turbulence and high velocity). These conditions in the primary thermocatalytic chamber 30 ensure highly efficient thermal transfer from the exhaust/processed gases to the processable material 44.

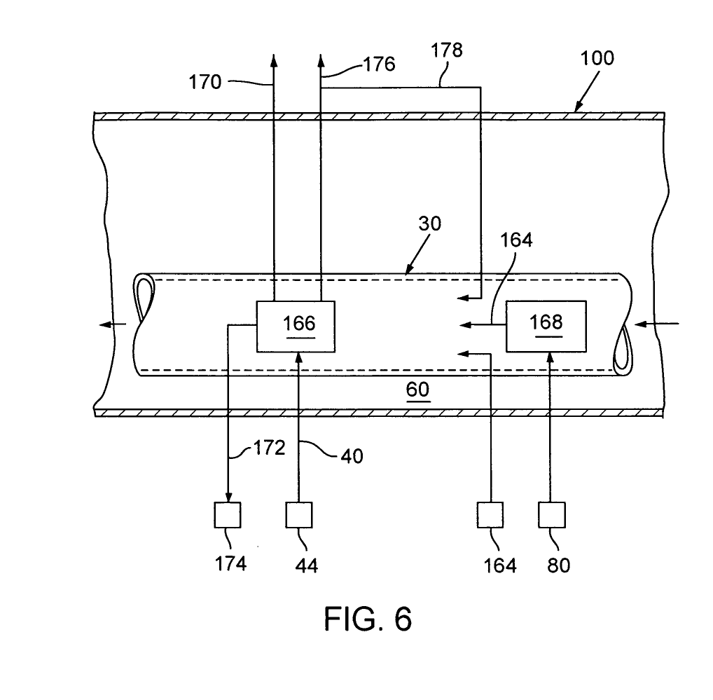

If more enhanced thermal-transfer efficiency is desired in the primary thermocatalytic chamber 30 than achievable from the flow of hot exhaust/processed gases alone, then, as shown in FIG. 6 for example, superheated steam 164 can be introduced upstream of a process chamber 166. (Thermal transfer from the flow of hot exhaust/processed gases to the processable material 44 is generally increased in such a scheme in view of the greater thermal affinity of superheated steam compared to air or gases in air.) The steam 164 can be supplied externally or can be produced in the primary thermocatalytic chamber 30 in a boiler 168 or the like supplied with water, wherein the steam thus produced is introduced directly into the primary thermocatalytic chamber 30. Both schemes are shown in FIG. 6. The processable material 44 is supplied to the process chamber 166 (e.g., an evaporation chamber) that is heated by contact with the flow of extremely hot exhaust/processed gases. Thus, heat is transferred to the processable material 44. Volatiles 170 of a first type (e.g., non-aqueous volatiles) released from the processable material can be condensed (see FIG. 5) or otherwise captured. Non-volatiles 172 can be collected 174, and volatiles 176 of a second type (e.g., aqueous volatiles) can be collected and condensed or reintroduced 178 as steam into the primary thermocatalytic chamber 30. Combustible volatiles can be routed upstream for combustion in the combustion head 22, for example, or collected for use elsewhere.

Condensation

As already discussed, portion(s) of the processable material that have been vaporized (e.g., in the primary thermocatalytic chamber 30) can be recovered by condensation. If desired, this recovered product can be used on-site. From a practical standpoint, such a condenser is located outside the respective thermocatalytic chamber. Whereas use of a condenser is one way in which to recover volatiles, vaporized material alternatively can be recovered in a condenser-less manner. In an example of the latter, the produced vapor is mixed with a particulate non-combustible material to which the vapor is adsorbed or in which the vapor is absorbed. The resulting suspension can be passed through a filter, de-mister, or analogous device, or collected by centrifugation. In any event, collected vaporized material can be used on-site, prepared for transportation elsewhere, or discarded.

Another way in which to conduct condensation, especially of aqueous liquids, is by introducing the liquid into the tank. For example, a waste water or brine can be used as the liquid 60 in the tank. During operation of the apparatus, the liquid in the tank (kept at a substantially constant level as already discussed) reaches an equilibrium temperature at or near the boiling temperature of the liquid. The vapor thus produced can be condensed and utilized as purified water. Meanwhile, solutes (e.g., salts) and particulates left behind in the tank can be precipitated and removed from the tank, such as through the port 117, as required, including on a continuous basis. The material removed from the port 117 usually is in a highly concentrated suspension. This suspension can be routed through a precipitator, a cyclone filter, or other type of solid-liquid separator(s), as well as a drier as required to remove residual liquid. The removed liquid can be recycled back into the tank and the solids utilized elsewhere.

Multi-Stage Processing

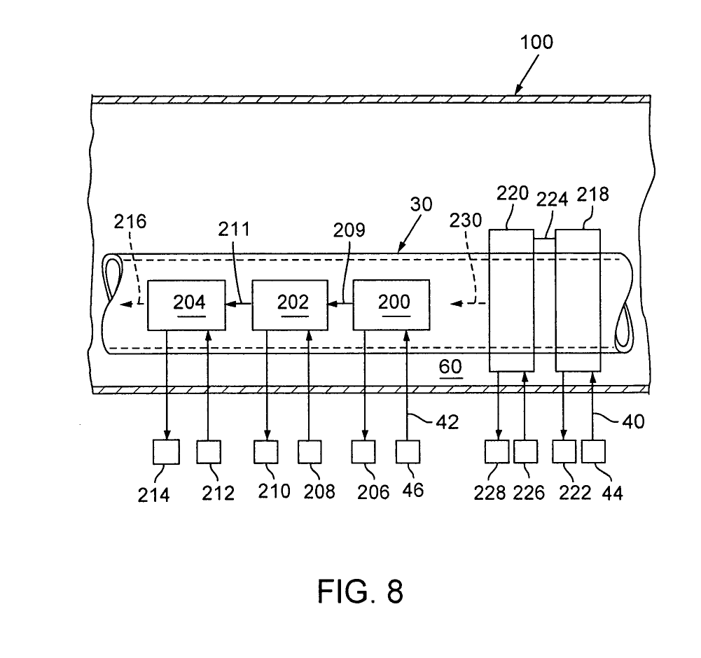

The thermal processor apparatus can perform any of various processes involving variable or staged thermal processing. For example, a staged process (one involving multiple thermal steps) can be conducted in the primary thermocatalytic chamber 30 or in the secondary thermocatalytic chamber 34, or respective steps can be conducted in both chambers. For example, a first step, requiring very high temperature, of a staged process can be conducted in the primary thermocatalytic chamber 30, and a second step, requiring lower temperature, can be conducted in the secondary thermocatalytic chamber 34. In another example, a first step can be conducted in an upstream portion of the primary thermocatalytic chamber 30 and a second step can be conducted in a downstream portion of the primary thermocatalytic chamber where the temperature is lower than in the upstream portion. A third step, requiring even lower temperature, can be conducted in the secondary thermocatalytic chamber 34. It is readily appreciated that the thermal gradients in the thermocatalytic chambers can be exploited in any of various ways for conducting a wide variety of staged processes. Versatility is further enhanced by compartmentalizing gases and liquids as required. See, e.g., discussion later below concerning FIG. 8.

Processing of released volatiles and gases can also include steps such as absorption into dessicants (followed by desiccant dehydration), and passage through high-temperature loops as required. Other processing of these materials can be performed such as activated-carbon adsorption and passage through catalytic matrices (e.g., catalytic conversion of volatile organic carbons such as conducted with automobile exhaust). The latter is especially facilitated by the high temperature of the volatiles and gases.

A multi-staged process also can be applied to steam production using the thermal-processor apparatus. Representative product ranges from high-pressure, high-temperature dry steam, low-pressure steam, wet steam, and even hot water. Such a process can include a condensation step by which the water can be purified.

It is also contemplated that the heat energy produced by the thermal processor apparatus can be utilized in a refrigeration cycle. Thus, a source of cold, as well as heat, can be provided at a remote site, for example. It is also contemplated that the heat energy can be utilized for power production, such as passing steam through a turbine connected to an electrical generator.

Vapor Processing

Vapor (as a processable material) can be processed by direct contact in either or both of the thermocatalytic chambers 30, 34. Alternatively, the vapor can be processed by immersion contact (passage of the vapor through a separate chamber or conduit situated in the thermocatalytic chamber), in which thermal transfer is achieved by conduction through the walls of the conduit or chamber. Product gases from such processing can be condensed to liquid using a variable-temperature condenser or by passage through a catalytic cracker to produce lower molecular weight compounds. Product gas usable as a fuel can be combined with the fuel 12 supplied to the combustion head 22. This product gas can be dehydrated, filtered, and/or compressed, if required. Filtration can be performed using, for example, a membrane filter, bag filter, or high-temperature ceramic, as in the PRISM process.

As discussed elsewhere herein, vapor processing encompasses, if desired, condensing vapor produced by the liquid 60 (e.g., water) in the tank. Such condensation can provide a ready supply of fresh water, for example, that can be used for any of various purposes. Condensation also results in concentration of the solutes and particulates left behind in the tank. These residual materials can be precipitated, agglomerated, aggregated, or the like. For example, removing water from many types of residual materials can substantially expand the options for use and/or disposal of the materials.

Energy Recovery from Low-Grade Gases and Liquids

Thermocatalytic combustion of various gases and liquids, for recovery of energy from them, can be performed in the primary thermocatalytic chamber 30. The gases can include low-grade gases, such as but not limited to “wet” gases such as biogas or well-head gas. The liquids can include, but are not limited to, water contaminated with volatile organic carbons (VOCs). Either gas or liquid can be introduced, as a processable material 44, as a stream into the primary thermocatalytic chamber 30 at an appropriate temperature location in the chamber. Alternatively or in addition, the gas can added to the fuel line or introduced directly into the combustion head 22 for vortexing with the air-fuel mixture and combustion in the flame chamber 28. If the processable material 44 (particularly a combustible gas) is introduced into the primary thermocatalytic chamber 30, downstream of the flame chamber 28, an actual flame may be produced in the primary thermocatalytic chamber downstream of the point(s) of introduction. If this presents a problem, then the material 44 can be introduced further upstream, in the flame chamber 28.

As noted, the inside walls 182 of the primary thermocatalytic chamber 30 can be provided with vortex-inducing vanes 184, 186 (FIG. 7) or the like for establishing and maintaining a vortexed flow of the hot exhaust gases as these gases propagate downstream in the primary thermocatalytic chamber. This vortexed flow can be useful for increasing the efficiency with which introduced processable material 44 is thermally processed in the primary thermocatalytic chamber 30. If necessary or appropriate for the particular processable material 44, a stream 188 of air, oxygen, or other oxidizing gas can also be introduced into the primary thermocatalytic chamber 30 to facilitate thermal processing and/or more complete oxidation of the processable material. Concentration of oxidizing gas (e.g., oxygen) in the primary thermocatalytic chamber 30 can be monitored using one or more gas sensors 190. The sensor(s) desirably are connected in a feedback-control manner (using a microprocessor for example) for regulating the volume (and concentration) of oxidizing gas in the primary thermocatalytic chamber, thereby ensuring complete combustion and/or proper conditions for thermal processing of the material.

As a processable material, low-grade gas typically contains a variety of substances, many of which are processable in the primary thermocatalytic chamber 30. One common contaminant is water. Similarly, VOC-laden water and the like have substantial amounts of water and frequently various particulate substances. In the primary thermocatalytic chamber 30, substantially all the water in the introduced processable material is instantly vaporized and converted to superheated steam. Most if not all the entrained or emulsified VOCs are combusted, and any non-combustible material of this nature can be recovered downstream by catalytic oxidation, for example. Many other contaminants, including certain particulate and particulate-forming contaminants, can be thermo-catalyzed by the hot exhaust gases from the flame chamber 28 as these gases are vortexed at high velocity in the flame chamber and primary thermocatalytic chamber. Also, the extremely hot exhaust gases moving under vortexed flow are very effective in comminuting particulate matter in the processable material 44.

If desired, the primary thermocatalytic chamber 30 can be fitted with a containment-ring collector 196 or the like (e.g., centrifugal collector), configured for continuous scavenging of particulates from a fluid stream. In the containment-ring collector 196 a vortexed flow of material entering the collector urges outward movement of particles that are held and collected in the ring. The ring typically is configured for continuous removal of collected particulates. Removing these particulates can be useful for preventing otherwise possible fouling contact of the particles with the inner walls of the primary thermocatalytic chamber 30 or further downstream.

Vapors, especially steam, produced in the primary thermocatalytic chamber 30 from the processable material 44 are accelerated to very high velocity as they propagate downstream. (Also, the great expansion exhibited by steam formation for water provides a very large boost to fluid velocity downstream from the primary thermocatalytic chamber 30.) This high-velocity vapor substantially and advantageously increases thermal-transfer efficiency with downstream surfaces and materials for processing purposes. For example, thermal-processing devices or surfaces placed in the primary thermocatalytic chamber 30 readily absorb this thermal energy for transfer to other media for use in performing any of various processes. Exemplary media include, but are not limited to, desiccants, steam, absorption-cooling or transfer oil, reactive surfaces, catalysts, etc. Again, the extremely high velocity of expanding superheated steam in the primary thermocatalytic chamber 30 greatly improves thermal transfer on heat-exchanger surfaces contacted by the steam and exhaust gases. Very high transfer numbers are thus achieved.

The exhaust gases (as well as gaseous products of thermal processes conducted in the primary thermocatalytic chamber 30) propagate through the primary thermocatalytic chamber 30 to the dry loop. The immersion of the thermocatalytic chambers 30, 34 in the liquid 60 cools the walls of the chambers while allowing substantial thermal transfer from the chambers to the liquid. As noted, the liquid 60 is circulated through the first and second liquid-processing chambers 24, 26. As the liquid 60 vaporizes off, it is continuously replaced by the supply 80. Meanwhile, the gases in the secondary thermocatalytic chamber 34 enter the processed/exhaust gas diffuser 32. In the processed/exhaust gas diffuser 32, the gases pass through the diffuser apertures 142 to the surrounding liquid 60 in the first liquid-processing chamber 24. Gases entering the liquid 60 give up their heat by velocity expansion and contraction of collapsing gases as well as by latent-heat transfer of vapor. As the bubbles 64, 144 rise in the liquid 60, the gases in the bubbles are scrubbed by the liquid before entering the atmosphere 66 above the liquid level. During this scrubbing, certain compounds (e.g., CO₂, S, particulates) are absorbed by the liquid, where they may be available for precipitation, formation of a floc, or other advantageous reaction that produces a scavengeable or collectable product.

Variable Thermal Transfer

The primary and secondary thermocatalytic chambers 30, 34 provide respective ranges of temperatures that can be recovered and used in any of many different thermal processes. The wide range of available temperatures is also conveniently exploited in various “step-process” thermal processes (processes requiring multiple thermal steps at different respective temperatures). Selecting a particular temperature for exploitation in a desired process can be achieved by placing one or more reaction chambers at respective locations in the appropriate thermocatalytic chamber. FIG. 8 depicts an example in which multiple reaction chambers 200, 202, 204 are placed inside the primary thermocatalytic chamber 30. The reaction chambers 200, 202, 204 are connected together in series in this example. A processable material 46 is introduced into the first reaction chamber 200 for processing at relatively high temperature found upstream in the primary thermocatalytic chamber 30. The first reaction chamber 200 may produce, from the processable material 46, a product 206 that can be collected. From the first reaction chamber, further processable material 209 enters the second reaction chamber 202, which also can receive a reactant or other processable material 208, for processing at a lower temperature. The second reaction chamber 202 may produce a product 210 that can be collected. From the second reaction chamber 202, further processable material 211 enters the third reaction chamber 204, which also can receive a reactant or other processable material 212, for processing at a further lower temperature. The third reaction chamber 204 may produce a product 214 that can be collected or discharged 216 into the primary thermocatalytic chamber 30.

FIG. 8 also depicts a configuration involving multiple reaction chambers 218, 220 situated around the primary thermocatalytic chamber 30. A processable material 44 enters the first reaction chamber 218 for processing at a higher temperature. The process conducted in the first reaction chamber 218 may produce a product 222 that can be collected. Processable material 224 passes from the first reaction chamber 218 to the second reaction chamber 220 for processing at a lower temperature. If necessary, the second reaction chamber 220 can receive other processable material 226. The process conducted in the second reaction chamber 220 may produce a product 228 that can be collected or discharged 230 into the primary thermocatalytic chamber 30.

The configurations of reaction chambers shown in FIG. 8 can also, or alternatively, be utilized with the secondary thermocatalytic chamber 34 as required or desired to exploit the heat being produced in the secondary thermocatalytic chamber. Thus, either or both thermocatalytic chambers 30, 34 can be used for performing staged energy transfer and multi-staged generation of product. The various configurations of reaction chambers offer an unlimited number of applications and design possibilities.

It will be understood that the term “reaction chamber” is not limited to a chamber in which a chemical reaction occurs, but rather encompasses chambers used for any of various heat-exploiting, heat-consuming (endothermic) processes, and even exothermic processes. Example processes include, but are not limited to, phase changes, filtration, absorption, desorption, adsorption, sequestations, thermal conversions, and any of various other processes.

Uses of Excess Air

The subject apparatus can make use of spent, high-temperature “exhaust” gas and air (as well as steam or other vapor, especially if formed or added) as a motive thermal carrier for use in conducting processes. Use of such gas, in the primary thermocatalytic chamber 30 for example, for direct-contact evaporation of a processable material provides significantly increased performance of the apparatus compared to, for example, conventional immersion-tube evaporators. Also, the volume, flow profile, and velocity of these carrier gases provide substantially increased thermal transfer to the processable material, compared to conventional systems.

Thermal Vapor Condensation

Vapor- and droplet-recovery systems can be employed that utilize heat produced by the thermal processor apparatus to maintain a specific temperature(s) useful for condensing and collecting one or more specific materials just below the flashpoint(s) of the materials. The exploited temperature can be controlled to within a narrow range, which is useful for minimizing carry-over of other product. Depending upon the processable material, thermal-vapor condensation can be performed in the primary thermocatalytic chamber 30, the secondary thermocatalytic chamber 34, or further downstream such as in a location that captures heat from the liquid 60 in the tank 100 or from the atmosphere in the tank above the liquid level (e.g., before the atmosphere is discharged through the stack 70). As discussed generally above, turbulence- or vortex-inducing vanes or the like can be utilized at the process location to achieve a desired perturbation of gas flow, which can be useful in recovering mists, condensates, and/or particulates from the gas stream. If desired, a cooling mist (e.g., of water droplets) can be applied to the vapor stream to reduce the temperature of the stream to a desired dew point for better condensation and more efficient collection. Enthalpy control and/or temperature control can be utilized to control the vapor temperature if used for establishing and controlling a temperature in a mist-eliminator, for example.

Desalination

Water desalination is an exemplary solute-removal process that is an important application of the subject thermal processor apparatus, and can be performed at any of various locations in the apparatus. For example, desalination can be conducted in the primary thermocatalytic chamber 30. To such end, a stream of brine or brackish water can be introduced directly into the primary thermocatalytic chamber, in which the water component is instantly converted to steam. The steam and other vaporized material can be collected by condensation (yielding substantially purified water for any of various uses), or by using a mist-eliminator. Residual heat in condensates can be passed through a heat exchanger or the like to return usable heat to the thermal processor. Recovered particulates, salt crystals, and the like can be collected using, for example, a bag filter or electro-precipitation.

In addition for use in desalination of water, the thermal processor apparatus also can be used for concentrating any of various materials such as ethylene glycol or other de-icing material, suspensions or solutions of heavy metals, etc. Again, if the condensate is water, the water can be used for make-up liquid in the tank or for any of various other processes requiring purified water. As noted above, this water can be distilled, using heat recovered by the thermal processor apparatus, for potable use. Alternatively or in addition, product water having a purity sufficient for ground water can be reintroduced back into the ground at a well-site, for example.

Fuel Consolidation

As already noted, the thermal processor apparatus can be used for distilling any of various liquid solutions and suspensions. In addition to or alternatively to distilling water and other aqueous fluids, the apparatus can be used for distilling and concentrating any of various materials for use as a fuel, either in the apparatus itself or elsewhere. For example, the apparatus can be used for increasing the concentration and purity of hydrogen peroxide, after transportation, for use as a fuel. Similarly, combustible materials can be concentrated for more efficient or convenient use as a fuel. Materials concentrated or purified by the apparatus need not be consumed by the apparatus or used at the site of the apparatus; concentrated materials usually can be more easily and/or less expensively transported. At their destination, reconstitution or dilution for use is usually relatively simple and inexpensive to perform.

In-Situ Oil-Recovery Processing

The thermal processor apparatus can be advantageously utilized for increasing production in an oil field that may require secondary and/or tertiary oil-recovery methods to restore or maintain productivity. For example, the apparatus is useful in a field in which water production or availability limits viable recovery from the well (e.g., the water is too contaminated inherently or due to it being production water, the water is saturated or laden with solutes, suspended solids, and/or emulsions). Water in any of these and other conditions can be readily processed using the apparatus to separate water from at least a portion of the contaminants, wherein the water can now be used for another purpose and the collected contaminants can be handled in a more environmentally sensitive manner. If the water is hot in its available state, the water can be introduced as such into the apparatus for thermal recovery from the water. If the water contains VOCs, thermal energy can be recovered from the VOCs as discussed above, thereby reducing the amount of energy supplied to the apparatus directly as fuel.

Water processed by the apparatus can be injected into a slow or retired oil well to re-open or reinvigorate the well. The injected water is at a purity level so as not to have adverse environmental consequences after injection, and also so as to be effective in, for example, dissolving calcium silicates and sulfates that may be clogging the well. In addition, the apparatus is capable of processing water at a sufficient rate so as to provide an adequate volume of water for this purpose. If desired (and if environmental regulations permit), acid and/or solubilizers can be added to enhance the effect of water injection.

In-Situ CO₂ and Nitrogen Generation

There is long-felt need for convenient sources of injection gas (notably nitrogen and carbon dioxide) for use at well-sites for increasing the yield of liquid or gaseous petroleum from the well. This important need is now addressed by the subject thermal processor apparatus that produces substantial amounts of these gases in situ. As the exhaust gases (including gaseous products of any of various processes conducted using the apparatus) propagate through the apparatus, contaminant substances are removed and recovered (or combusted). The remaining “flue” gas, particularly as discharged from the processed/exhaust gas diffuser 32, typically contains substantial concentrations of mist-laden N₂ and CO₂. These gases can be de-misted and separated using conventional methods and, instead of simply being discharged through the stack 70, utilized for injection into a well. (In addition, the water removed during de-misting is also available for on-site use.) Both these gases, when introduced into a well clogged by highly viscous petroleum, are effectively dissolved in the petroleum and tend to reduce the viscosity of the petroleum. Thus, the petroleum is more easily extracted and the well is “opened” up.

The apparatus also can be used for collecting and sequestering CO₂ that is present or produced at an oil-recovery site as a by-product of oil-production. This CO₂ is normally considered a liability because of the conventional difficulty of removing it. But, if the oil-site could benefit from injection of the CO₂ back into the well(s), the benefit of a supply of CO₂ produced on site by the apparatus is evident.

The apparatus is extremely useful for enhancing the condition of substances (such as water) before release into the environment. This release is not limited to surface release. For example, at oil production sites, strict environmental regulations pertain to the condition of water introduced back into a well to increase production from the well. Water that has undergone at least some restoration using the apparatus can now be utilized in this manner. The advantages of this use are especially notable when consideration is given to the fact that the apparatus can be operated from the product of the well. Hence, the apparatus can be transported to and used at remote sites to restore wells that previously would have been given up entirely.

Fully Saturated Flue-Gas Flood Technology

Follow-up flood technology that uses fully saturated flue gas to recover bound oil in situ is new and exciting. This technology uses miscible gas combined with distilled water vapor to scrub and detach oil from oil sand and rock formations, including shale. Chemical and polymer solubilizers can also be used for enhanced recovery. The subject thermal processor apparatus allows the water used in this recovery process to be processed and reused. Also, the chemicals in the water are now recoverable, and the extracted oil is dehydratable using the apparatus. By-products of the process (e.g., N₂ and CO₂) can be re-injected into a well, which further enhances oil recovery by reducing the viscosity of the oil in the well.

Whereas the invention has been described in connection with multiple representative embodiments and examples, the invention is not limited to those examples. On the contrary, the invention is intended to encompass all modifications, alternatives, and equivalents as may be included within the spirit and scope of the invention, as defined by the appended claims.

What is claimed is:

1. A thermal processing apparatus, comprising:
a first liquid-processing chamber and a second liquid-processing chamber, the first and second liquid processing chambers each containing a liquid, wherein the liquid in the second liquid-processing chamber has a higher level than the liquid in the first liquid-processing chamber;
a flame chamber submerged in the liquid in the first liquid-processing chamber, the flame chamber containing a flame substantially within the flame chamber;
a thermocatalytic chamber coupled downstream of the flame chamber and submerged in the liquid in the first liquid-processing chamber, the thermocatalytic chamber receiving thermal energy produced upstream thereof;
a dry loop coupled to the thermocatalytic chamber, the dry loop including an elevated portion, relative to the thermocatalytic chamber, and being submerged in the liquid in the second liquid-processing chamber while being higher than the thermocatalytic chamber, the dry loop conducting thermal energy and processed/exhaust matter produced upstream thereof while preventing liquid incursion upstream thereof; and
a processed/exhaust gas diffuser coupled downstream of and submerged in the liquid in the first liquid-processing chamber lower than the dry loop, the processed/exhaust gas diffuser receiving thermal energy and processed/exhaust matter exiting the dry loop and discharging at least some of the thermal energy and matter as bubbles into the liquid in the first liquid-processing chamber;
wherein the thermocatalytic chamber is configured to execute at least one thermal process, utilizing at least a portion of the thermal energy received therein, on a processable material in thermal contact with the first thermocatalytic chamber.

2. The apparatus of claim 1, further comprising a combustion head coupled upstream of the flame chamber, the combustion head producing a flame from ignition of fuel and an oxidizer introduced into the combustion head, the flame supplying at least some thermal energy and exhaust gases to the thermocatalytic chamber.

3. The apparatus of claim 2, wherein the combustion head comprises a device that forms a vortexed flame in, and coextensive with, the flame chamber.

4. The apparatus of claim 1, wherein:
the processable material is introduced into the thermocatalytic chamber; and
the thermal process is executed inside the thermocatalytic chamber, utilizing at least some of the thermal energy received into the thermocatalytic chamber.

5. The apparatus of claim 1, wherein:
the thermocatalytic chamber constitutes a primary thermocatalytic chamber submerged beneath the liquid level in the first liquid-processing chamber; and
the apparatus further comprises a secondary thermocatalytic chamber coupled between the dry loop and the processed/exhaust gas diffuser and being higher than the first thermocatalytic chamber, the secondary thermocatalytic chamber receiving thermal energy from upstream thereof and executing at least one thermal process, utilizing at least a portion of the received thermal energy, on an introduced processable material in thermal contact with the secondary thermocatalytic chamber.

6. The apparatus of claim 1, wherein at least the flame chamber is longitudinally extended in a substantially horizontal direction.

7. The apparatus of claim 1, wherein the thermocatalytic chamber comprises an accessory with which the thermal process is executed on the processable material introduced to the accessory.

8. The apparatus of claim 1, wherein:
the first liquid-processing chamber contains an atmosphere above the liquid level in the firsts liquid-processing chamber, the atmosphere containing a vapor; and
the apparatus further comprises a vapor-recovering device that removes at least some of the vapor from the atmosphere.

9. The apparatus of claim 1, wherein:
the liquid in the second liquid-processing chamber flows into the first liquid-processing chamber; and
the apparatus further comprises a liquid-level-maintenance device configured to maintain at least one of the respective liquid levels in the first and second liquid-processing chambers at a predetermined respective level.

10. The apparatus of claim 1, wherein at least the thermocatalytic chamber comprises a flow-director.

11. The apparatus of claim 10, wherein the flow-director comprises at least one member configured to impart a vortexed flow of the matter through the thermocatalytic chamber.

12. The apparatus of claim 1, wherein the processed/exhaust gas diffuser comprises a diffuser tube comprising walls defining diffuser apertures through which thermal energy and matter exit the diffuser tube as bubbles introduced into the liquid in the first liquid-processing chamber.

13. The apparatus of claim 12, wherein the processed/exhaust gas diffuser further comprises a diffuser screen situated to receive the bubbles introduced into the liquid and to break up the bubbles as the bubbles pass through the screen.

14. The apparatus of claim 1, wherein:
the flame chamber and first thermocatalytic chamber conduct respective gases at velocities and temperatures sufficient to form ionizing environments in the flame chamber and first thermocatalytic chamber;
the ionizing environments form ionic species of matter flowing through the flame chamber and first thermocatalytic chamber;
the processed/exhaust gas diffuser discharges hot gases in the bubbles discharged into the liquid in the first liquid-processing chamber; and
the ionic species and discharged hot gases provide a cathodic property that buffers the liquid and inhibits apparatus corrosion.

15. The apparatus of claim 1, wherein the liquid flows from the second liquid-processing chamber to the first liquid-processing chamber.

16. A thermal processing apparatus, comprising:
first and second liquid-processing chamber means;
means for maintaining respective liquid levels in the first and second liquid-processing chamber means such that the liquid level in the second liquid-processing chamber means is higher than the liquid level in the first liquid-processing chamber means;
flame-chamber means for receiving and containing a flame, the flame-chamber means being submerged in the liquid in the first liquid-processing chamber means and providing a hot fluid stream comprising hot gases;
thermocatalytic chamber means for receiving the hot fluid stream and for transferring at least a portion of the thermal energy from the fluid stream to at least one thermal process conducted by the thermocatalytic chamber means on a processable material introduced to the thermocatalytic chamber means, the thermocatalytic chamber means being submerged in the liquid in the first liquid-processing chamber means;
dry-loop means for preventing incursion of liquid into the thermocatalytic chamber means and flame-chamber means, the dry-loop means being submerged in liquid in the second liquid-processing chamber means at a higher elevation than the thermocatalytic chamber means; and
processed/exhaust gas diffuser means, submerged in the liquid in the first liquid-processing chamber at a lower elevation than the dry-loop means, for receiving hot gases and matter from the dry-loop means and for discharging the hot gases and matter as bubbles into the liquid in the first liquid-processing chamber means.

17. The apparatus of claim 16, further comprising combustor means for producing the flame received by the flame-chamber means.

18. The apparatus of claim 16, wherein the thermocatalytic chamber means constitutes a first portion located upstream of but lower than the dry-loop means and a second portion located between the dry-loop means and the processed/exhaust gas diffuser means but higher than the first portion.

19. The apparatus of claim 16, wherein the thermocatalytic chamber means comprises accessory means for performing the thermal process on the processable material.

20. The apparatus of claim 19, wherein the accessory means comprises vortexing means.

21. A method for performing a thermal process on a processable material, comprising:
providing a fluid stream;
directing the fluid stream through a thermocatalytic chamber in which the fluid stream gains thermal energy;
with the thermocatalytic chamber and using at least a portion of the thermal energy in the fluid stream, executing a thermal process on an introduced processable material while maintaining submersion of the thermocatalytic chamber in a liquid to control temperature of the thermocatalytic chamber, thereby producing a stream of processed/exhaust gases exiting the thermocatalytic chamber;
directing the stream of processed/exhaust gases through a diffuser submerged in the liquid so as to form the stream into bubbles discharged into the liquid; and
upstream of the diffuser, directing flow of the processed/exhaust gases through a dry loop that is submerged in a liquid but at a level higher than the thermocatalytic chamber to prevent upstream incursion of the liquid into the thermocatalytic and flame chambers.

22. The method of claim 21, wherein the fluid stream in the thermocatalytic chamber gains thermal energy by passage from a flame chamber located upstream of the thermocatalytic chamber.

23. The method of claim 21, further comprising:
passing the fluid stream, downstream of the thermocatalytic chamber, through a second thermocatalytic chamber;
maintaining submersion of the second thermocatalytic chamber in a liquid, at a level higher than the thermocatalytic chamber, to control temperature of the second thermocatalytic chamber; and
with the second thermocatalytic chamber and using at least a portion of the thermal energy in the stream of processed/exhaust gases, executing a second thermal process on an introduced processable material, thereby producing a stream of processed/exhaust gases exiting the second thermocatalytic chamber to the diffuser.

24. The method of claim 21, wherein the thermal process is selected from the group consisting of evaporation, condensation, vapor processing, energy recovery, solute removal, concentration, consolidation, gas generation, combustion, material conversion, purification, chemical reaction, and phase change.

25. The method of claim 21, further comprising:
combusting a stream of fuel and an oxidizer to form a flame; and
containing the flame in the flame chamber.
